(19) United States
(12) Patent Application Publication
(10) Pub. No.: US 2007/0284989 A1
(43) Pub. Date: Dec. 13, 2007

(54) Composition for preparing electron emission source, electron emitter prepared using the composition, electron emission device including the electron emitter, and method of preparing the electron emitter

(76) Inventor: Joong-Woo Nam, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/708,486

(22) Filed: Feb. 21, 2007

(30) Foreign Application Priority Data
Feb. 22, 2006 (KR) 10-2006-0017298

(51) Int. Cl. H01J 29/00; H01B 1/24

(52) U.S. Cl. 313/364; 252/511

(57) ABSTRACT

An electron emission source composition includes a carbon-based material and a carrier, wherein the composition exhibits a thixotropic value of about 10,000 Pa/s to about 50,000 Pa/s and a viscoelectricity value of about 2 to about 5.

### BACKGROUND OF THE INVENTION

1. Field of the Invention

The present invention relates to electron emission devices. In particular, the present invention relates to a composition of an electron emission source and an electron emitter, a device and a method employing the same, wherein the composition of the electron emission source exhibits improved printability and leveling properties.

2. Description of the Related Art

Electron emission devices are display devices capable of displaying images by extracting electrons from electron emission sources of a cathode and accelerating the electrons through an electric field against phosphorescent layers to trigger emission of visible light therefrom and form images.

Conventional electron emission sources may include carbon-based materials with good electrical conductivity and low work function to provide good conductivity, high field enhancement effect, enhanced field emission properties, and low driving voltage. Once the composition of the electron emission source is prepared, it may be printed onto a cathode.

However, the conventional composition of the electron emission source may lack an efficient viscosity range. In particular, the conventional composition of the electron emission source may have thixotropy values higher than 200,000 Pa/s or lower than 8,000 Pa/s and viscoelectricity values of 5 or higher, thereby providing inefficient continuous printing and poor leveling properties of the cathode.

Accordingly, there exists a need to improve the composition of the electron emission source of the electron emission device in order to provide enhanced printing and leveling properties.

### SUMMARY OF THE INVENTION

The present invention is therefore directed to a composition of an electron emission source and electron emitter, device and method employing the same, which substantially overcome one or more of the disadvantages of the related art.

It is therefore a feature of an embodiment of the present invention to provide a composition of an electron emission source having improved printability and leveling properties.

It is therefore another feature of an embodiment of the present invention to provide an electron emission source employing a composition capable of providing improved printability and leveling properties.

It is yet another feature of an embodiment of the present invention to provide an electron emission display employing an electron emission source having a composition capable of providing improved printability and leveling properties.

It is still another feature of an embodiment of the present invention to provide a method of manufacturing an electron emission source having a composition capable of providing improved printability and leveling properties.

At least one of the above and other features and advantages of the present invention may be realized by providing an electron emission source composition, including a carbon-based material and a carrier, wherein the composition exhibits a thixotropic value of about 10,000 Pa/s to about 50,000 Pa/s and a viscoelectricity value of about 2 to about 5.

The amount of carbon-based material may be from about 0.1 to about 30 parts by weight and the amount of the carrier may be from about 70 to about 99.9 parts by weight as based on 100 parts by weight of the composition. Further, the carrier may include from about 3 to about 20 parts by weight of a polymer component and from about 80 to about 97 parts by weight of an organic solvent component based on 100 parts by weight of the carrier.

The polymer component may be a cellulose-based resin, an acryl-based resin, a vinyl-based resin, or a mixture thereof. The organic solvent component may be butyl carbitol acetate (BCA), terpineol (TP), toluene, texanol, butyl carbitol (BC), or a mixture thereof. The carbon-based material may be carbon nanotubes, graphite, diamond, and fullerene.

The electron emission source composition may further include at least one additive, wherein the additive may be an adhesive component, a filler, a photosensitive resin, a photoinitiator, a viscosity modifier, a resolution modifier, a dispersant, a defoamer, or a combination thereof. The amount of the additive may be from about 0.5 to about 30 parts by weight based on 100 parts by weight of the composition.

The filler may include any one of silver (Ag), aluminum (Al), palladium (Pd) and aluminum-oxide (Al₂O₃). The adhesive component may include glass frit, silane, water glass, ethyl cellulose, nitro cellulose, polyester acrylate, epoxy acrylate, urethane acrylate, a vinyl-based resin, a metal, or a combination thereof.

In another aspect of the present invention, there is provided an electron emission device, including a substrate, at least one cathode disposed on the substrate, and at least one electron emission source electrically connected to the cathode, wherein the electron emission source includes an electron emission source composition having a carbon-based material and a carrier and exhibiting a thixotropic value of about 10,000 Pals to about 50,000 Pa/s and a viscoelectricity value of about 2 to about 5.

The amount of carbon-based material may be from about 0.1 to about 30 parts by weight as based on 100 parts by weight of the composition. The carrier may in clued from about 3 to about 20 parts by weight of a polymer component and from about 80 to about 97 parts by weight of an organic solvent component based on 100 parts by weight of the carrier. The composition may further include at least one additive, the additive being an adhesive component, a filler, a photosensitive resin, a photoinitiator, a viscosity modifier, a resolution modifier, a dispersant, and a defoamer. The filler may include silver (Ag), aluminum (Al), palladium (Pd) and aluminum-oxide (Al₂O₃).

In yet another aspect of the present invention, there is provided a method of preparing an electron emission source, including mixing a carbon-based material and a carrier to form an electron emission source composition exhibiting a thixotropic value of about 10,000 Pa/s to about 50,000 Pa/s and a viscoelectricity value of about 2 to about 5, printing the electron emission source composition onto a substrate, sintering the electron emission source composition with the substrate to form a sintered electron emission source composition, and activating the sintered electron emission source composition.

Sintering the electron emission source composition may include heating at a temperature of from about 350° C. to about 500° C.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a partial sectional view of an electron emission device according to an embodiment of the present invention;

FIG. 2 illustrates a schematic view of an electric discharge apparatus for producing carbon nanotubes according to an embodiment of the present invention;

FIG. 3 illustrates a graph of thixotropic values of electron emission source compositions of Examples 1-3 and Comparative Example 1;

FIG. 4 illustrates a graph for thixotropic values of electron emission source compositions of Examples 4 to 6 and Comparative Example 1;

FIGS. 5A-5B illustrate photographs of sectional and plane views of an electron emission source and a distribution of electron emission sources manufactured in accordance with Example 1, respectively;

FIGS. 6A and 6B illustrate photographs of sectional and plane views of an electron emission source and a distribution of electron emission sources manufactured in accordance with Example 2, respectively;

FIGS. 7A and 7B illustrate photographs of sectional and plane views of an electron emission source and a distribution of electron emission sources manufactured in accordance with Example 3, respectively;

FIGS. 8A and 8B illustrate photographs of sectional and plane views of an electron emission source and a distribution of electron emission sources manufactured in accordance with Example 4, respectively;

FIGS. 9A and 9B illustrate photographs of sectional and plane views of an electron emission source and a distribution of electron emission sources manufactured in accordance with Example 5, respectively;

FIGS. 10A and 10B illustrate photographs of sectional and plane views of an electron emission source and a distribution of electron emission sources manufactured in accordance with Example 6, respectively; and

FIGS. 11A and 11B illustrate photographs of sectional and plane views of an electron emission source and a distribution of electron emission sources manufactured in accordance with Comparative Example 1, respectively.

### DETAILED DESCRIPTION OF THE INVENTION

Korean Patent Application No. 10-2006-0017298, filed on Feb. 22, 2006, in the Korean Intellectual Property Office, and entitled: Composition for Preparing Electron Emission Source, Electron Emitter Prepared Using the Composition, Electron Emission Device Including the Electron Emitter, and Method of Preparing the Electron Emitter,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

It will further be understood that when an element is referred to as being “on” another element or substrate, it can be directly on the other element or substrate, or intervening elements may also be present. Further, it will be understood that when an element is referred to as being “under” another element, it can be directly under, or one or more intervening elements may also be present. In addition, it will also be understood that when an element is referred to as being “between” two elements, it can be the only element between the two elements, or one or more intervening elements may also be present. Like reference numerals refer to like elements throughout.

An exemplary electron emission source composition of the present invention will now be discussed in more detail. In particular, the electron emission source composition of the present invention may include from about 0.1 to about 30 parts by weight of a carbon-based material and from about 70 to about 99.9 parts by weight of a carrier based on 100 parts by weight of the total composition.

The carbon-based material of the electron emission source composition may be any carbon-based material having excellent conductivity and electron emission properties to facilitate electron emission toward phosphorescent layers and excitation thereof. For example, the carbon-based material may be any one of carbon nanotubes (CNT), graphite, diamond, fullerene, and like materials.

Preferably, the carbon-based material may be carbon nanotubes. The carbon nanotube is a carbon allotrope that may include a graphite sheet rolled to form a single or a multi walled tube having a diameter on a nano-scale by a thermal chemical vapor deposition (CVD), e.g., DC plasma CVD, RF plasma CVD, or microwave plasma CVD. Both single-walled nanotubes and multi-walled nanotubes may be used in embodiments of the present invention.

The carrier of the electron emission source composition according to an embodiment of the present invention may be any fluid capable of adjusting the viscosity and printability of the electron emission source composition. The carrier may include from about 3 to about 20 parts by weight of a polymer component and from about 80 to about 97 parts by weight of an organic solvent component based on 100 parts by weight of the carrier.

Non-limiting examples of the polymer component may include a cellulose resin, e.g., ethyl cellulose, nitro cellulose, and so forth; an acryl-based resin, e.g., polyester acrylate, epoxy acrylate, urethane acrylate, and so forth; a vinyl-based resin, and so forth. Non-limiting examples of the organic solvent component may include butyl carbitol acetate (BCA), terpineol (TP), toluene, texanol, butyl carbitol (BC), and so forth.

The electron emission source composition according to an embodiment of the present invention may further include at least one additive in an amount of from about 0.5 to about 30 parts by weight based on 100 parts by weight of the electron emission source composition. For example, the at least one additive of the electron emission source composition may include an adhesive component to increase adhesion between the carbon nanotubes and a surface to which the carbon nanotubes may be applied. The adhesive component may include any one of an inorganic adhesive component, e.g., glass frit, silane, water glass, and so forth, an organic adhesive component, e.g., a cellulose-based resin, such as ethyl cellulose, nitro cellulose, and so forth; an acryl-based resin, e.g., polyester acrylate, epoxy acrylate, urethane acrylate, and so forth; a vinyl-based resin; a metal having a low melting point; or a combination thereof. The additive of electron emission source composition may also include a filler, e.g., silver (Ag), aluminum (Al), palladium (Pd), aluminum-oxide (Al₂O₃), and so forth, to increase the conductivity of the carbon nanotubes and adjust thixotropic values and/or other material properties of the electron emission source composition. Additionally, the additive of the composition of the electron emission source may include any one of a photosensitive resin, a viscosity modifier, a resolution modifier, a photoinitiator, a dispersant, a defoamer, and so forth.

The electron emission source composition according to an embodiment of the present invention may exhibit a thixotropic value of about 10,000 Pa/s to about 50,000 Pa/s and a viscoelectricity value of about 2 to about 5. The thixotropic value may be measured at a temperature of about 20-25° C., while modifying a shear rate from about 0 [1/s] to about 100 [1/s] and measuring a shear stress by a standard rheometer having two plates positioned 1 mm apart from each other. The viscoelectricity value may be evaluated at a temperature of 20-25° C., frequency range of 0.05-100 Hz, and shear stress of 1-10 Pa by a dynamic viscoelectricity measurement via a standard rheometer having two plates positioned 1 mm apart from each other.

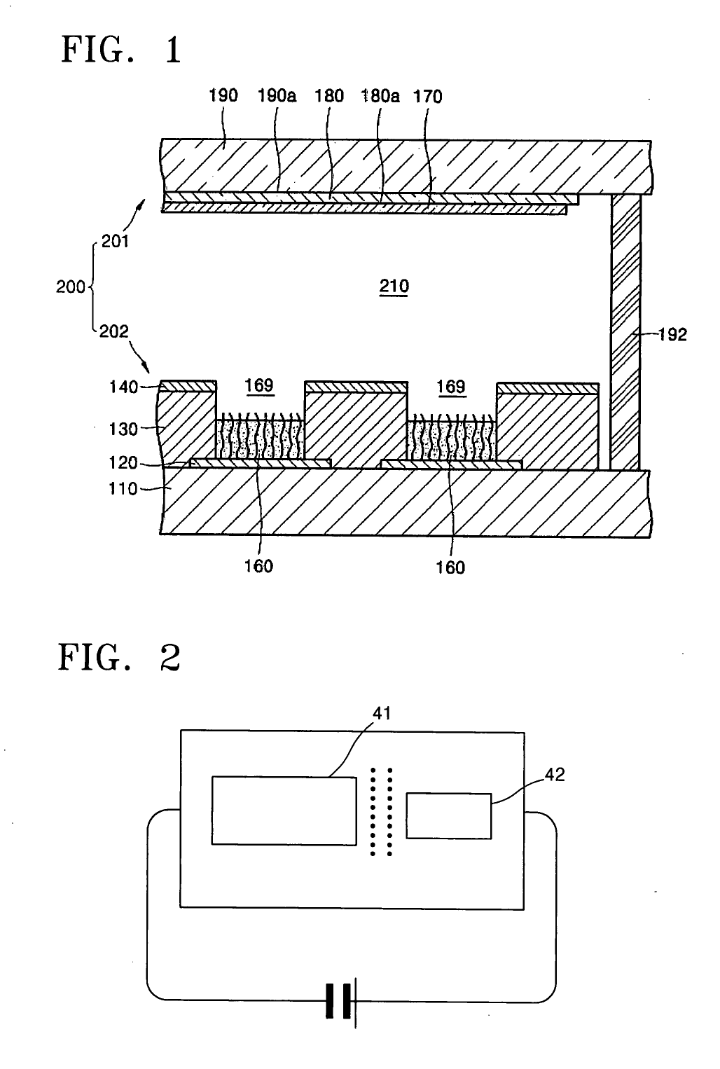

In another aspect of the present invention, an exemplary embodiment of an electron emission device 200 employing the electron emission source composition described above will be described with respect to FIG. 1.

The electron emission device 200 may include an upper plate 201 and a lower plate 202. The upper plate 201 of the electron emission device 200 may include an upper substrate 190, an anode 180 formed on a lower surface 190a of the upper substrate 190, and at least one phosphor layer 170 formed on a lower surface 180a of the anode 180. The anode 180 may provide a sufficiently high voltage to accelerate electrons toward the at least one phosphor layer 170. The phosphor layer 170 may include at least one unit pixel (not shown) having a red phosphor layer (not shown), a green phosphor layer (not shown), and a blue phosphor layer (not shown) disposed on the lower surface 180a of the anode 180. Accordingly, accelerated electrons may collide with the phosphor layer 170 at a high speed to facilitate excitation thereof and emission of energy in a form of visible light.

The lower plate 202, as further illustrated in FIG. 1, may be positioned in parallel to the upper plate 201 and at a predetermined distance therefrom. Further, the lower plate 202 may include a lower substrate 110, a plurality of cathodes 120 disposed in a stripe pattern on the lower substrate 110, a plurality of gate electrodes 140 disposed in a stripe pattern and perpendicularly to the cathodes 120 to facilitate emission of electrons, an insulating layer 130 disposed between the gate electrodes 140 and the cathodes 120 to insulate therebetween, a plurality of electron emission holes 169 defined by the insulating layer 130 and the gate electrodes 140, and a plurality of electron emission sources 160 disposed in the electron emission holes 169 and electrically connected to the cathodes 120. The cathodes 120 may be made from any material and according to any method known in the art, e.g., a transparent conductive material such as indium tin oxide (ITO).

The electron emission sources 160 may be disposed on the cathodes 120 to have a thickness that is lower than a thickness of the insulation layer 130 to provide the electron emission sources 160 at a lower height level as compared to a height of the gate electrodes 140. The electron emission sources 160, which emit electrons due to an electric field, are prepared using the composition described in detail above.

The electron emission device 200, as further illustrated in FIG. 1, may also include a plurality of spacers 192 disposed between the upper plate 201 and the lower plate 202. In particular, the spacers 192 may be positioned between the upper and lower plates 201 and 202 for support thereof and for defining an emission space 210 therebetween. In this respect, it should be noted that the emission space 210 may be maintained at a pressure that is below an atmospheric pressure. It should further be noted that the upper plate 201 and the lower plate 202 may be attached by connecting the upper substrate 190 of the upper plate 201 to the lower substrate 110 of the lower plate 202, such that the electrodes, i.e., the cathodes 120, the gate electrodes 140, and the anode 180, and the phosphor layer 170 are positioned therebetween.

According to another aspect of the present invention, an exemplary method of preparing an electron emission source according to an embodiment of the present invention is as follows. First, a carbon-based material, a polymer, an organic solvent, and optionally at least one additive may be mixed to form the electron emission source composition as described above. Preferably, at least one adhesive component may be included in the electron emission source composition to enhance adhesion between the carbon-based material and a substrate, wherein the term “substrate” refers to any substrate intended for electron emission source formation, e.g., an upper surface of a cathode. In addition, melting and solidifying at least a portion of the adhesive component may enhance durability and minimize outgasing of the electron emission source composition.

Next, the electron emission source composition may be printed onto the substrate. Printing of the electron emission source composition onto the substrate may be determined with respect to presence/absence of a photosensitive resin in the electron emission source composition. In particular, if the electron emission source composition includes a photosensitive resin, it may be print-coated onto the substrate, and subsequently, exposed and developed according to a desired pattern of the electron emission source to form a printed electron emission source composition. Alternatively, if the electron emission source composition does not include a photosensitive resin, a photolithography process, i.e., use of photoresist film pattern, may be required. For example, a photoresist film may be used to form a photoresist film pattern, and subsequently, the electron emission source composition may be printed via the photoresist film pattern to form a printed electron emission source composition.

Next, the printed electron emission source composition may be sintered to enhance adhesion between the printed electron emission source composition and the substrate and form a sintered electron emission source composition. The sintering temperature may be determined according to the temperature and time required for evaporation of the organic solvent and sintering of the adhesive component. For example, the sintering may be performed at a temperature of from about 350° C. to about 500° C., and preferably at about 450° C. In this respect, it should be noted that when the sintering temperature is below about 350° C., the organic solvent may not evaporate sufficiently. On the other hand, when the sintering temperature exceeds about 500° C., the carbon-based material may be damaged.

Subsequently, the sintered electron emission source composition may be activated to prepare an electron emission source. For example, the sintered electron emission source composition may be coated with a polyimide polymer-containing surface treatment agent, and subsequently, cured to form a film. The film may be further heated and delaminated to activate the electron emission source.

Alternatively, an adhesive portion may be formed on a surface of a roller driven by a driving source to press the sintered electron emission source composition to a predetermined pressure, thereby activating the electron emission source. In this respect, it should be noted that if carbon nanotubes are employed as a carbon-based material, the carbon nanotubes may be exposed on the surface of the electron emission source or vertical alignment of the carbon nanotubes may be adjusted during activation.

Once the electron emission source is activated, it may be integrated into an electron emission device. An exemplary electron emission device may be prepared as follows. The cathodes 120 may be made of ITO and disposed on the lower substrate 110 in a stripe-pattern. Next, an insulating material, i.e., polymide, may be screen-printed on the cathodes 120 to form the insulating layer 130. Subsequently, a paste containing a conductive material, e.g., silver (Ag), copper (Cu), aluminum (Al), and so forth, may be screen-printed onto the insulating layer 130 to form a plurality of gate electrodes 140. The gate electrodes 140 may be treated via a photolithography process to form a stripe pattern, such that the plurality of gate electrodes 140 may be parallel to one another and perpendicular to the cathodes 120.

Next, the gate electrodes 140 and the insulating layer 130 may be etched to expose the cathodes 120, thereby defining the electron emission holes 169. Next, an electron emission source composition may be prepared and coated in the electron emission holes 169 to finalize the electron emission sources, as will be described in detail below.

### EXAMPLES

Carbon nanotubes were prepared according to an electric discharge method, as illustrated in FIG. 2, for use as a carbon-based material in the electron emission source composition according to an embodiment of the present invention.

In particular, two graphite bars were respectively used as a cathode 41 and an anode 42. It should be noted, however, that two metal bars may be used for forming the cathode 41 and the anode 42 as well. Direct current was applied to the cathode 41 and anode 42 to generate discharge therebetween, while the cathode 41 was maintained at a lower temperature as compared to the anode 42. Consequently, a large quantity of electrons was generated by the discharge to collide with the anode 42, thereby detaching a carbon crust from the anode 42. The low temperature of the cathode 41 facilitated condensation of the carbon crust thereon to prepare carbon nanotubes.

The carbon nanotubes were mixed with glass frit, ethyl cellulose, methyl acryl acid, butyl carbitol, and different types and amounts of a filler component to form 7 samples of an electron emission source composition, i.e., Examples 1-6 and Comparative Example 1. Each sample of the electron emission source composition was evaluated for its thixotropy and viscoelectricity values.

The thixotropic values were obtained by measuring a difference between increasing and decreasing shear rates of each sample. In particular, each sample was subjected to shear rate at a temperature of 20-25° C. and at a frequency of 10 Hz. The shear rate was gradually increased from 0 [1/s] to 100 [1/s], while the shear stress was measured with a standard rheometer. Next, the shear rate was gradually decreased from 100 [1/s] to 0 [1/s], while the shear stress was measured with the standard rheometer. In this respect, it should be noted that the standard rheometer included two plates positioned 1 mm apart from each other, such that the measured sample was placed therebetween. Subsequently, the results of the measurements were plotted into a graphic form, i.e., shear stress as a function of shear rate illustrating a hysteresis loop, wherein the slope at each point represented the viscosity. The thixotropy values were obtained by calculating the area of the hysteresis loop.

Similarly, the viscoelectricity values were obtained by measuring viscosity and elasticity with respect to varying frequency, i.e., dielectric loss tangent−tan δ. In particular, the ratio of the viscosity coefficient, i.e., ratio of shear stress to shear rate, to a storage coefficient was evaluated at a temperature of 20-25° C., frequency range of 0.05-100 Hz, and shear stress of 1-10 Pa by dynamic viscoelectricity measurement via a standard rheometer. The standard rheometer employed to obtain viscoelectricity values included two plates positioned 1 mm apart from each other, such that the measured sample was placed therebetween.

### Example 1

2 g of carbon nanotubes were mixed with 20 g of glass frit, 6 g of ethyl cellulose, 12 g of methyl acryl acid, 60 g of butyl carbitol acetate and 5 g of silver to form an electron emission source composition. The measured thixotropic value was 23,500 Pa/s.

### Example 2

an electron emission source composition similar to the composition of Example 1 was prepared with the exception that 10 g of silver was used. The measured thixotropic value was 11,000 Pa/s.

### Example 3

an electron emission source composition similar to the composition of Example 1 was prepared with the exception that 20 g of silver was used. The measured thixotropic value of the composition was 23,360 Pa/s.

### Example 4

an electron emission source composition similar to the composition of Example 1 was prepared with the exception that 5 g of aluminum oxide was used instead of silver. The measured thixotropic value of the composition was 20,960 Pa/s.

### Example 5

an electron emission source composition similar to the composition of Example 4 was prepared with the exception that 10 g of aluminum oxide was used. The measured thixotropic value of the composition was 14,850 Pa/s.

### Example 6

an electron emission source composition similar to the composition of Example 4 was prepared with the exception that 20 g of aluminum oxide was used. The measured thixotropic value of the composition was 23,500 Pa/s.

### Comparative Example 1

an electron emission source composition similar to the composition of Example 1 was prepared with the exception that silver was not used. The measured thixotropic value of the composition was 7,670 Pa/s.

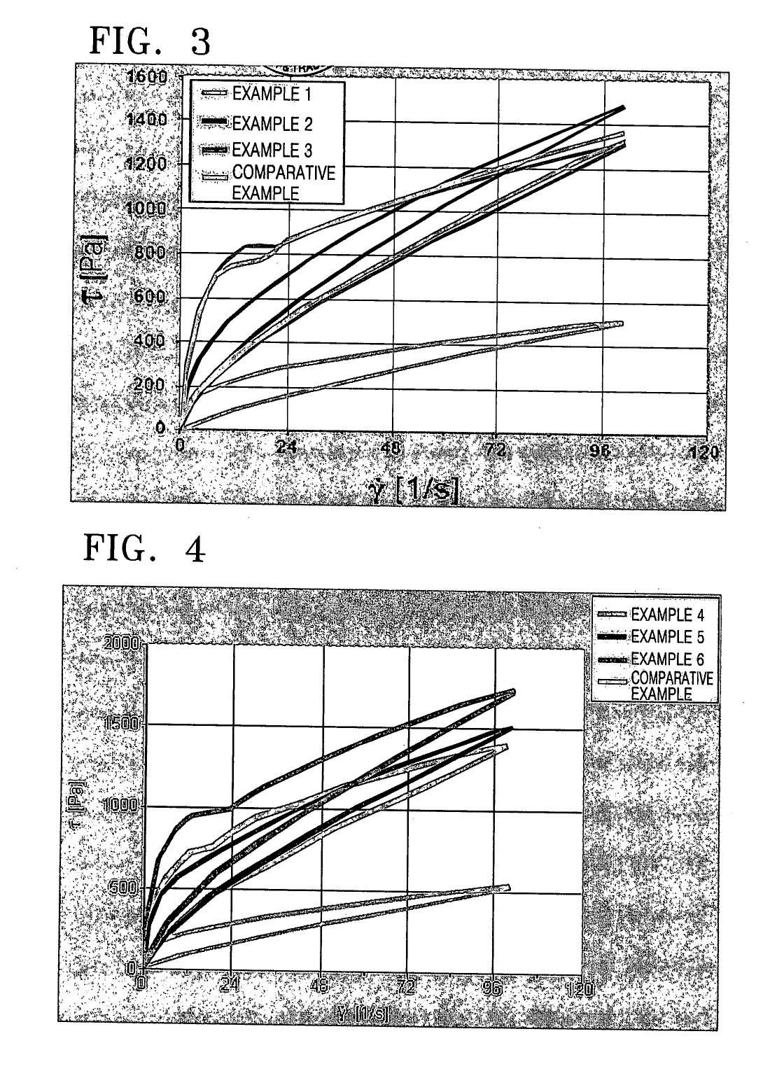

The thixotropic values of the electron emission source composition of Examples 1-3 as compared to Comparative Example 1 are illustrated in a graphic form in FIG. 3. Similarly, the thixotropic values of the electron emission source composition of Examples 4-6 as compared to Comparative Example 1 are illustrated in a graphic form in FIG. 4.

Preparation of Electron Emission Sources: the Electron Emission source compositions of Examples 1-6 and the Comparative Example 1 were respectively coated on substrates. Subsequently, a pattern mask was laid on the substrates. Next, the substrates were irradiated with 2000 mJ/cm² of energy using parallel exposure equipment. Following the exposure, the substrates were sprayed and developed. Finally, the substrates were sintered at a temperature of 450° C. to from electron emission sources.

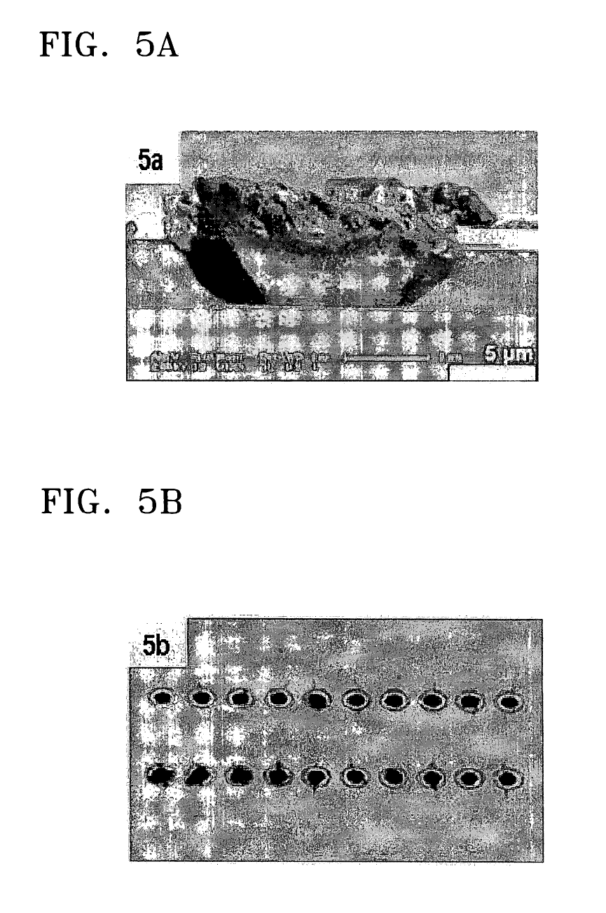

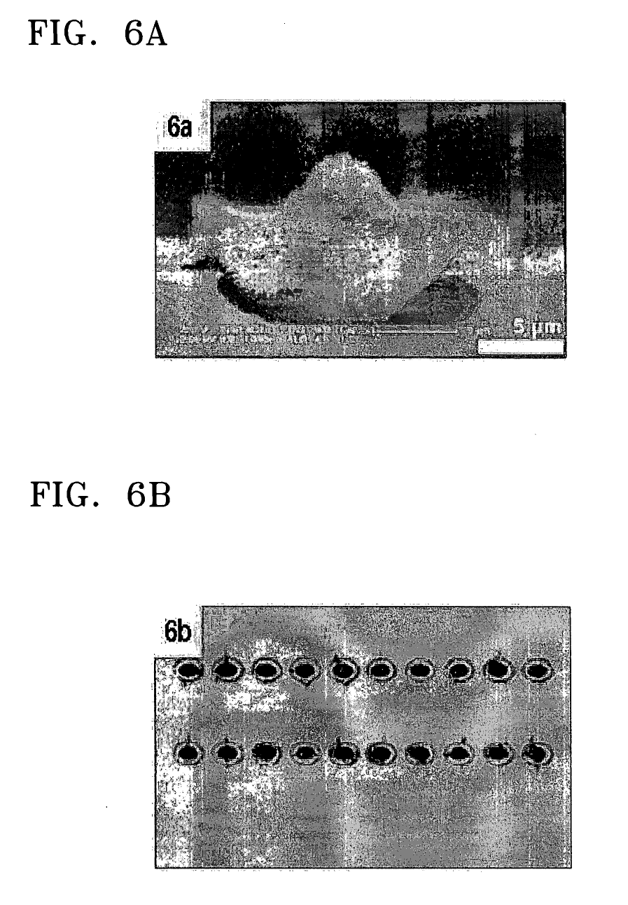

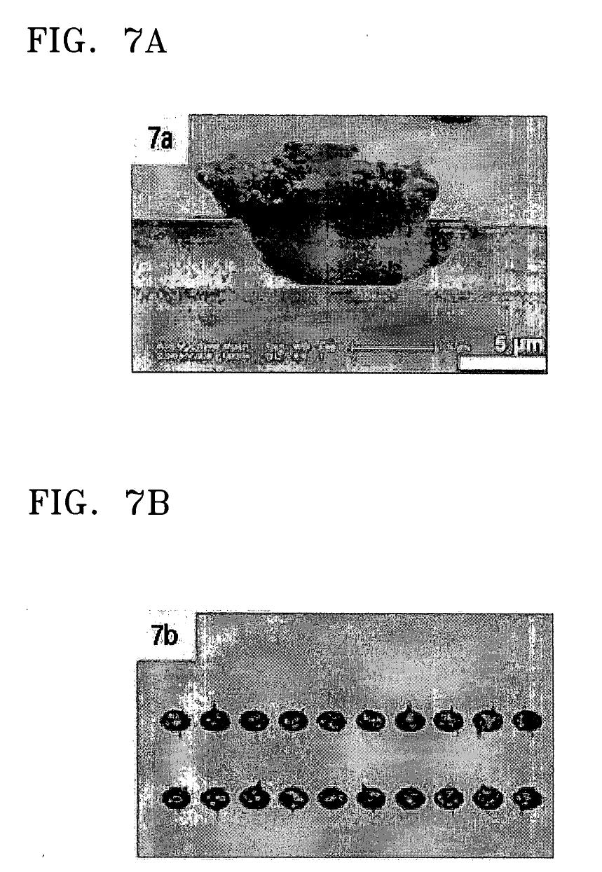

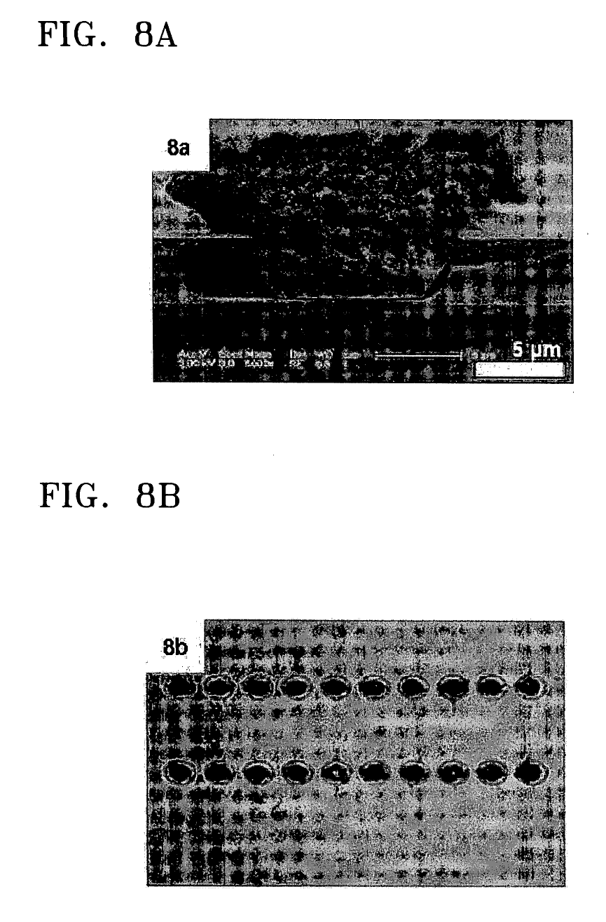

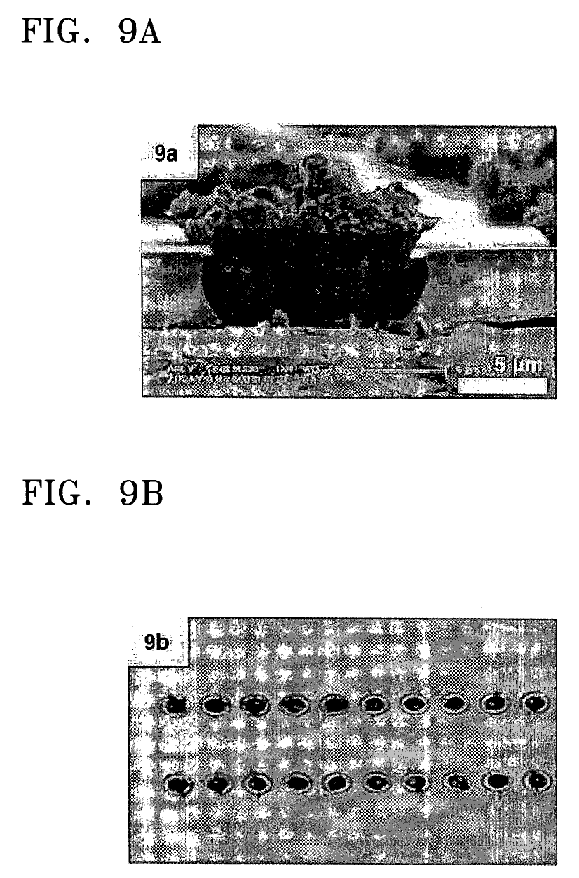

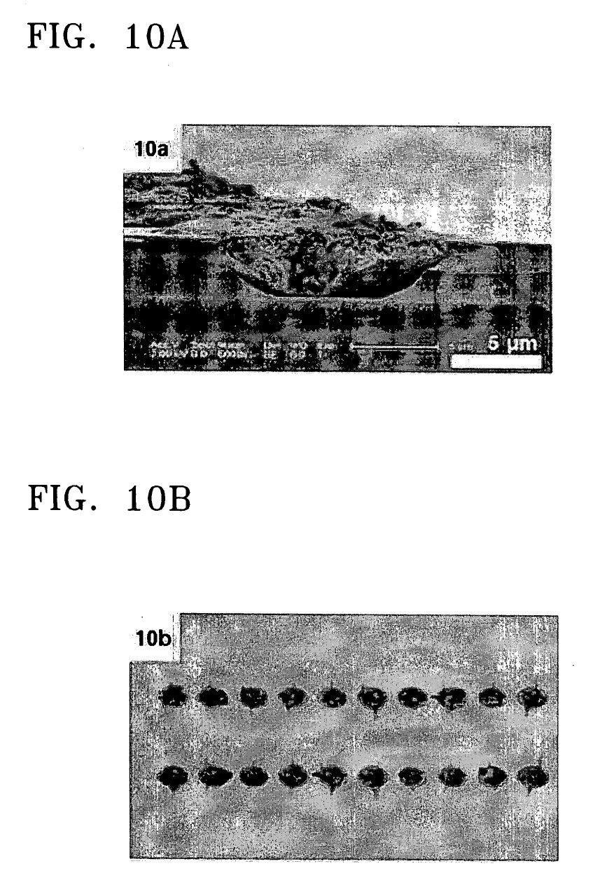

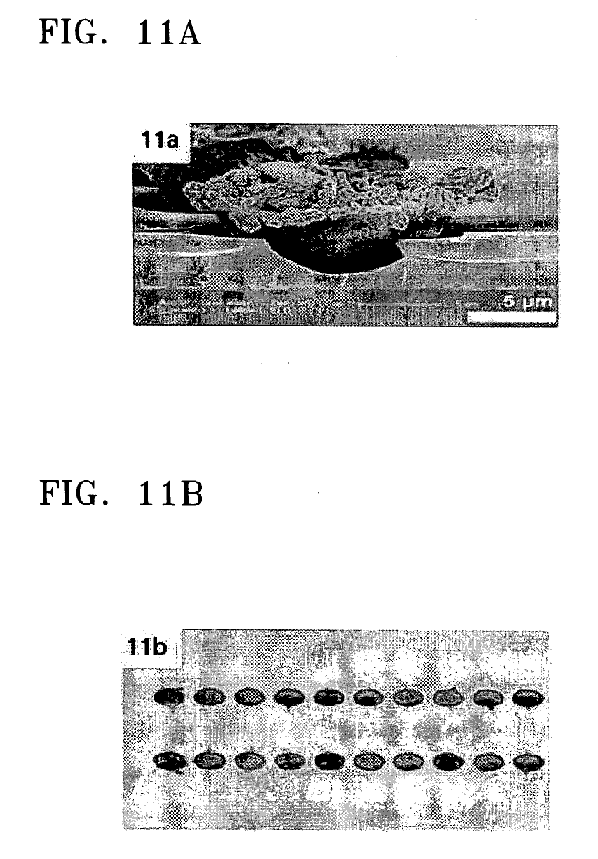

FIGS. 5A through 11B illustrate sectional photographs of the single electron emission source and plan photographs of the distribution of the electron emission sources prepared using the compositions for electron emission source formation according to Examples 1 to 6 and the Comparative Example 1.

Thixotropy and viscoelectricity values may be affected by the molar ratios of the polymer, the organic solvent, and the inorganic material included in the electron emission source composition, e.g., silver. In a conventional electron emission source composition the thixotropy values are higher than 200,000 Pa/s or lower than 8,000 Pa/s, and the viscoelectricity values are of 5 or higher. As can be seen from Examples 1-6, the thixotropy and viscoelectricity values of the electron emission source composition formed according to an embodiment of the present invention range from about 10,000 to about 50,000 Pa/s; a range of values that exhibits a decrease of at least about 4-fold, or alternatively, an increase of at least about 1.3-fold, in the thixotropic values as compared to thixotropic values of a conventional electron emission source composition. Similarly, the viscoelectricity values of the inventive electron emission source composition range from about 2 to about 5.

The thixotropy and viscoelectricity values of the inventive electron emission source composition may identify an optimal range of values to provide for enhanced printability and leveling properties. Accordingly, the process stability and operation of an electron emission device may be improved in terms of quality and reliability.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An electron emission source composition, comprising a carbon-based material and a carrier, wherein the composition exhibits a thixotropic value of about 10,000 Pa/s to about 50,000 Pa/s and a viscoelectricity value of about 2 to about 5.

2. The electron emission source composition as claimed in claim 1, wherein the amount of carbon-based material is from about 0.1 to about 30 parts by weight and the amount of carrier is from about 70 to about 99.9 parts by weight based on 100 parts by weight of the composition.

3. The electron emission source composition as claimed in claim 2, wherein the carrier comprises from about 3 to about 20 parts by weight of a polymer component and from about 80 to about 97 parts by weight of an organic solvent component based on 100 parts by weight of the carrier.

4. The electron emission source composition as claimed in claim 3, wherein the polymer component is a cellulose-based resin, an acryl-based resin, a vinyl-based resin, or a mixture thereof.

5. The electron emission source composition as claimed in claim 3, wherein the organic solvent component is butyl carbitol acetate (BCA), terpineol (TP), toluene, texanol, butyl carbitol (BC), or a mixture thereof.

6. The electron emission source composition as claimed in claim 2, further comprising at least one additive, the additive being an adhesive component, a filler, a photosensitive resin, a photoinitiator, a viscosity modifier, a resolution modifier, a dispersant, a defoamer, or a combination thereof.

7. The electron emission source composition as claimed in claim 6, wherein the amount of the additive is from about 0.5 to about 30 parts by weight based on 100 parts by weight of the composition.

8. The electron emission source composition as claimed in claim 6, wherein the filler includes any one of silver (Ag), aluminum (Al), palladium (Pd) and aluminum-oxide (Al₂O₃).

9. The electron emission source composition as claimed in claim 6, wherein the adhesive component includes glass frit, silane, water glass, ethyl cellulose, nitro cellulose, polyester acrylate, epoxy acrylate, urethane acrylate, a vinyl-based resin, a metal, or a combination thereof.

10. The electron emission source composition as claimed in claim 1, wherein the carbon-based material is any one of carbon nanotubes, graphite, diamond, fullerene, and like materials.

11. An electron emission device, comprising:
a substrate;
at least one cathode disposed on the substrate; and
at least one electron emission source electrically connected to the cathode, wherein the electron emission source includes an electron emission source composition having a carbon-based material and a carrier and exhibiting a thixotropic value of about 10,000 Pa/s to about 50,000 Pa/s and a viscoelectricity value of about 2 to about 5.

12. The electron emission device as claimed in claim 11, wherein the amount of carbon-based material is from about 0.1 to about 30 parts by weight based on 100 parts by weight of the composition.

13. The electron emission device as claimed in claim 12, wherein the carrier comprises from about 3 to about 20 parts by weight of a polymer component and from about 80 to about 97 parts by weight of an organic solvent component based on 100 parts by weight of the carrier.

14. The electron emission device as claimed in claim 11, further comprising at least one additive, the additive being an adhesive component, a filler, a photosensitive resin, a photoinitiator, a viscosity modifier, a resolution modifier, a dispersant, a defoamer, or a combination thereof.

15. The electron emission source composition as claimed in claim 14, wherein the filler includes any one of silver (Ag), aluminum (Al), palladium (Pd) and aluminum-oxide (Al₂O₃).

16. A method of preparing an electron emission source, comprising:
mixing a carbon-based material and a carrier to form an electron emission source composition exhibiting a thixotropic value of about 10,000 Pa/s to about 50,000 Pa/s and a viscoelectricity value of about 2 to about 5;
printing the electron emission source composition onto a substrate;
sintering the electron emission source composition with the substrate to form a sintered electron emission source composition; and
activating the sintered electron emission source composition.

17. The method as claimed in claim 16, wherein sintering the electron emission source composition includes heating at a temperature of from about 350° C. to about 500° C.
